(19) United States
(12) Patent Application Publication
(10) Pub. No.: US 2016/0201787 A1
(43) Pub. Date: Jul. 14, 2016

(54) RACK GUIDE MECHANISM

(71) Applicant: Showa Corporation, Gyoda-shi (JP)

(72) Inventor: Tsutomu KIMIJIMA, Haga-gun (JP)

(73) Assignee: Showa Corporation, Gyoda-shi (JP)

(21) Appl. No.: 14/750,280

(22) Filed: Jun. 25, 2015

(30) Foreign Application Priority Data
Jan. 9, 2015 (JP) 2015-003709

(51) Int. Cl. F16H 55/28

(52) U.S. Cl. CPC F16H 55/283

(57) ABSTRACT

A rack guide mechanism includes: a housing in which a housing chamber opening toward a rack shaft is formed; a screw screwing to the housing and forming a bottom wall of the housing chamber; a rack guide housed in the housing chamber, and supporting the rack shaft; and a compression coil spring interposed between a bottom surface of the housing chamber and the rack guide, constantly biasing the rack guide to the rack shaft side, in which an elastic body in a natural length state is fixed to one of the bottom surface of the housing chamber and a facing surface of the rack guide facing the bottom surface of the housing chamber.

### CROSS-REFERENCE TO RELATED APPLICATIONS

This application is based on and claims priority under 35 USC 119 from Japanese Patent Application No. 2015-003709 filed on Jan. 9, 2015, the entire content of which is incorporated herein by reference.

### BACKGROUND OF THE INVENTION

1. Technical Field

The present invention relates to a rack guide mechanism.

2. Related Art

There is a rack and pinion-type steering apparatus for a vehicle, in which a pinion gear is engaged with a rack gear to convert a rotary motion of a pinion shaft generated with a steering operation into a reciprocating motion of a rack shaft.

The above rack and pinion-type steering apparatus is commonly provided with a rack guide mechanism for reducing backlash between the pinion shaft and the rack gear as disclosed in JP-A-2007-203836 (Patent Literature 1).

The related-art rack guide mechanism includes a rack guide supporting the rack shaft, a compression coil spring constantly biasing the rack guide to the rack shaft side, a housing in which a housing chamber housing the rack guide is formed and a screw forming a bottom wall of the housing chamber.

Incidentally, wheels are connected to both ends of the rack shaft through tie rods. Accordingly, there is a case where an external force inputted to the wheels is transmitted to the rack shaft and the rack shaft presses the rack guide against a biasing force of the compression coil spring. As a result, there is a problem that a hammering sound (sound of contact) is generated as a bottom surface of the rack guide contacts a bottom surface of a housing chamber.

In order to solve the above problem, it can be considered that the biasing force of the compression coil spring is increased by increasing a screwing amount of the screw with respect to the housing or that a disc spring which constantly biases the rack guide to the rack shaft side is provided in addition to the compression coil spring.

However, in the above methods, a large biasing force acts even when the external force does not act on the rack shaft, which increases a friction force between the rack guide and the rack shaft. As a result, smooth sliding of the rack shaft with respect to the rack guide is impaired and the steering feeling may be deteriorated.

Accordingly, the rack guide mechanism which can increase the biasing force acting on the rack guide only when the external force acts and there is a danger that the bottom surface of the rack guide collides with the bottom surface of the housing chamber has been required.

### SUMMARY OF THE INVENTION

An aspect of the present invention is to provide a rack guide mechanism capable of increasing the biasing force acting on the rack guide only when the external force acts and there is a danger that the bottom surface of the rack guide collides with the bottom surface of the housing chamber.

According to an embodiment of the present invention, there is provided a rack guide mechanism including a housing in which a housing chamber opening toward a rack shaft is formed, a screw screwing to the housing and forming a bottom wall of the housing chamber, a rack guide housed in the housing chamber and supporting the rack shaft, and a compression coil spring interposed between a bottom surface of the housing chamber and the rack guide, constantly biasing the rack guide to the rack shaft side, in which an elastic body in a natural length state is fixed to one of the bottom surface of the housing chamber and a facing surface of the rack guide facing the bottom surface of the housing chamber.

According to the above configuration, as the elastic body is in the natural length state, an elastic force of an elastic body does not act on the rack guide as long as the facing surface of the rack guide or the bottom surface of the housing chamber does not collide with the elastic body. Accordingly, when an external force allowing the bottom surface of the rack guide to collide with the bottom surface of the housing chamber does not act, the biasing force acting on the rack guide is only the elastic force of the compression coil spring, therefore, smooth sliding of the rack shaft with respect to the rack guide can be secured and the good steering feeling can be obtained.

When the rack guide is pressed by the rack shaft and the facing surface of the rack guide or the bottom surface of the housing chamber collides with the elastic body, the elastic force of the elastic body acts on the rack guide in addition to the elastic force of the compression coil spring. Therefore, the biasing force acting on the rack guide is increased and the rack guide returns (moves) to the rack shaft side without the collision to the bottom surface of the housing chamber, which prevents the generation of the hammering sound.

The rack guide mechanism may have a configuration in which the elastic body is separated from the other of the bottom surface of the housing chamber and the facing surface of the rack guide in a moving direction of the rack guide.

Here, in the case where the elastic body abuts on the other of the bottom surface of the housing chamber and the facing surface of the rack guide, when the screwing amount of the screw is increased for increasing the biasing force of the compression coil spring, the elastic body is crushed and the elastic force of the elastic body acts on the rack guide.

Therefore, there is a danger that it is difficult to perform the adjustment work of increasing the elastic force of the compression coil spring by increasing the screwing amount of the screw.

On the other hand, as the elastic body is separated from the other of the bottom surface of the housing chamber and the facing surface of the rack guide in the above structure, the elastic body is hardly crushed even when the screwing amount of the screw is increased.

According to the configuration described above, the adjustment work of increasing the elastic force of the compression coil spring can be performed by increasing the screwing amount of the screw can be performed.

The rack guide mechanism may have a configuration in which a housing hole opening toward the bottom surface of the housing chamber and housing the compression coil spring is formed on a bottom surface of the rack guide, and that the facing surface of the rack guide corresponds to one of an annular surface which is the bottom surface of the rack guide and a housing bottom surface forming a bottom surface of the housing hole.

The rack guide mechanism may have a configuration in which the elastic body is fixed to the annular surface when being fixed to the facing surface of the rack guide.

The rack guide mechanism may have a configuration in which the elastic body is fixed to a portion facing the annular surface when being fixed to the bottom surface of the housing chamber.

According to the above configuration, the elastic body is interposed between the annular surface (bottom surface) of the rack guide and the bottom surface of the housing chamber, therefore, contact between the bottom surface of the rack guide and the bottom surface of the housing chamber can be avoided.

The rack guide mechanism may have a configuration in which the elastic body may be fixed to the housing bottom surface when being fixed to the facing surface of the rack guide.

The rack guide mechanism may have a configuration in which the elastic body may be fixed to a portion facing the housing bottom surface when being fixed to the bottom surface of the housing chamber.

According to the rack guide mechanism discussed above, it is possible to provide the rack guide mechanism capable of increasing the biasing force acting on the rack guide only when the external force acts and there is a danger that the bottom surface of the rack guide collides with the bottom surface of the housing chamber.

### BRIEF DESCRIPTION OF THE DRAWINGS

FIG. 1 is a schematic structural view of a motor-driven power steering apparatus;

FIG. 2 is a cross-sectional view showing a structure of a rack guide mechanism according to an embodiment;

FIG. 3 is a cross-sectional view showing a state where a rack guide is moved to a bottom surface side of a housing chamber; and

FIG. 4 is a cross-sectional view showing a structure of a rack guide mechanism according to a modification example.

### DETAILED DESCRIPTION OF THE INVENTION

An embodiment of the present invention will be explained with reference to the drawings. The embodiment will be explained by citing an example in which a rack guide mechanism of the present invention is applied to a motor-driven power steering apparatus, however, the present invention is not limited to this and may be applied to a hydraulic power steering apparatus and a manual steering apparatus.

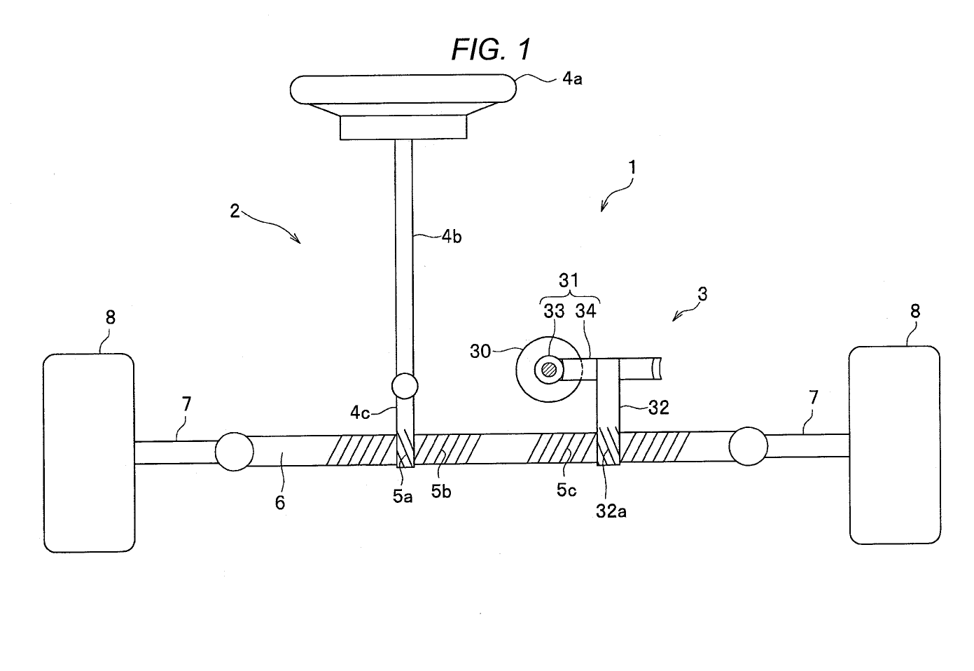

As shown in FIG. 1, a motor-driven power steering apparatus 1 is a rack and assist type apparatus including a steering mechanism 2 having a rack shaft 6 in which two rack gears which are a rack gear (steering wheel side) 5b and a rack gear (assist side) 5c are formed and an auxiliary torque mechanism 3 giving an auxiliary steering force to the rack shaft 6.

The steering mechanism 2 includes a steering wheel 4a operated by a driver, a steering shaft 4b rotating by the operation of the steering wheel 4a, a pinion shaft 4c provided on a lower side of the steering shaft 4b through a not-shown torsion bar and a rack shaft 6 to which right and left steered wheels 8, 8 are connected on both ends through tie rods 7, 7. A pinion gear (steering wheel side) 5a of the pinion shaft 4c is engaged with the rack gear (steering wheel side) 5b of the rack shaft 6. When the driver rotates the steering wheel 4a, the rack shaft 6 moves in a left direction or in a right direction to steer right and left steered wheels 8, 8.

The auxiliary torque mechanism 3 includes a motor for assistance 30, a worm gear mechanism 31 and an assist shaft 32 provided with a pinion gear (assist side) 32a, in which the pinion gear (assist side) 32a of the assist shaft 32 is engaged with the rack gear (assist side) 5c of the rack shaft 6.

The worm gear mechanism 31 includes a worm 33 rotatably attached to the motor for assistance 30 and a worm wheel 34 engaged with the worm 33. The worm wheel 34 is rotatably attached to the assist shaft 32. In the auxiliary torque mechanism 3, a torque added to the steering wheel 4a is detected by a not-shown torque sensor, and the motor for assistance 30 is driven and controlled by a not-shown control device in accordance with the detected torque. Accordingly, the generated torque of the motor for assistance 30 is transmitted to the rack shaft 6 as an auxiliary steering force through the worm gear mechanism 31 and the assist shaft 32.

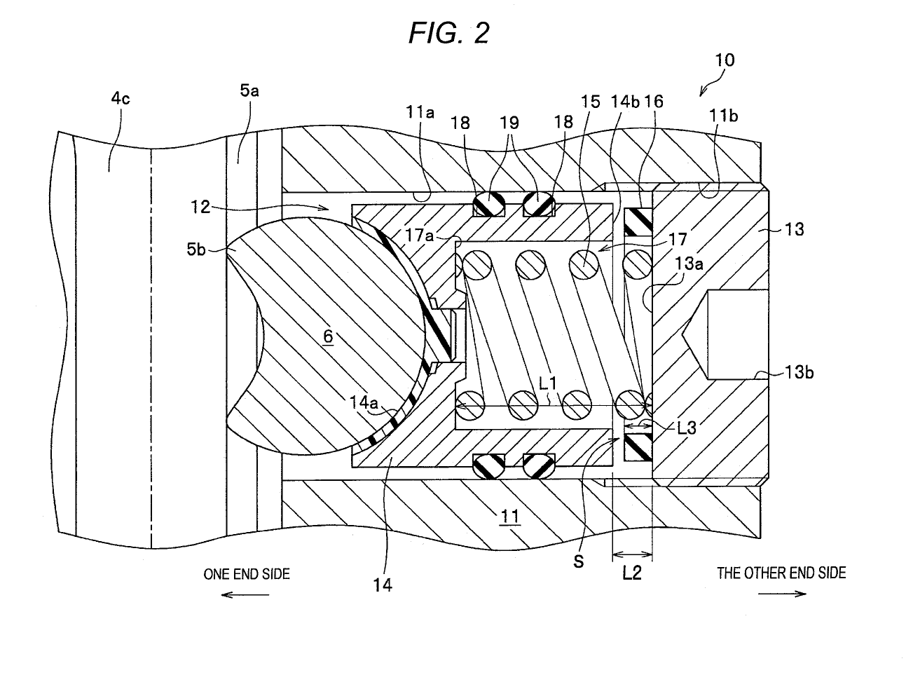

As shown in FIG. 2, the motor-driven power steering apparatus 1 is provided with a rack guide mechanism 10 for reducing backlash between the pinion gear (steering wheel side) 5a and the rack gear (steering wheel side) 5b in the steering mechanism 2.

In the following explanation, a state where the external force is not transmitted to the rack shaft 6 and the pinion gear (steering wheel side) 5a is not separated from the rack gear (steering wheel side) 5b is referred to as a normal state.

In the embodiment, the explanation will be made by citing an example in which the rack guide mechanism 10 is applied to the pinion gear (steering wheel side) 5a and the rack gear (steering wheel side) 5b in the steering mechanism 2, however, the present invention is not limited to the example. For example, the rack guide mechanism 10 according to the present invention can be applied to the pinion gear (assist side) 32a and rack gear (assist side) 5c in the auxiliary torque mechanism 3, or the rack guide mechanism 10 according to the present invention can be applied to both the steering mechanism 2 and the auxiliary torque mechanism 3.

The rack guide mechanism 10 includes a housing 11 in which a housing chamber 12 opening toward the rack shaft 6 is formed, a screw 13 screwing to the housing 11 and forming a bottom wall of the housing chamber 12, a rack guide 14 housed in the housing chamber 12 and supporting the rack shaft 6, a compression coil spring interposed between the screw 13 and the rack guide 14 and constantly biasing the rack guide 14 to the rack shaft 6 side and an elastic body 16 fixed to the screw 13.

The housing 11 is for housing various components such as the pinion shaft 4c and the rack shaft 6.

The housing chamber 12 is an approximately columnar through hole (space) extending linearly from the rack shaft 6, which is formed to be the opposite side of the pinion shaft 4c with the rack shaft 6 sandwiched therebetween.

Hereinafter, when directions are explained, a direction in which the housing chamber 12 extends is referred to as an “axial direction”, and a side in which the rack shaft 6 is arranged in the axial direction is referred to as “one end side” and a side in which the rack shaft 6 is not arranged in the axial direction is referred to as “the other end side”.

On the other end side of an inner peripheral surface 11a of the housing 11 facing the housing chamber 12, a screw groove 11b to which the screw 13 is screwed is formed.

The screw 13 is an approximately columnar member, which is screwed to the housing 11 to thereby form a closed bottom wall on the other end side of the housing chamber 12.

One end surface of the screw 13 forms a bottom surface 13a of the housing chamber 12. Hereinafter, one end surface of the screw 13 is referred to as the bottom surface 13a of the housing chamber 12.

On the other end surface of the screw 13, an engagement hole 13b with which a jig for rotating the screw 13 is engaged is formed. When the screw 13 is rotated by inserting the jig into the engagement hole 13b, the screw 13 is guided by the screw groove 11b to move to one end side or the other end side in the axial direction.

On one end surface of the rack guide 14, a sliding surface 14a on which the rack shaft 6 abuts (slides) is formed, which is formed to be an approximately arc shape so as to correspond to an outer peripheral surface of the rack shaft 6.

On the other end surface (hereinafter referred to as a “bottom surface”) 14b of the rack guide 14, a housing hole 17 opening to the bottom surface 13a of the housing chamber 12 and housing the compression coil spring 15 is formed. The bottom surface 14b of the rack guide 14 is an annular surface.

A facing surface of the rack guide 14 which faces the bottom surface 13a of the housing chamber 12 corresponds to the bottom surface (annular surface) 14b of the rack guide 14 and a housing bottom surface 17a forming a bottom surface of the housing hole 17.

Additionally, two annular grooves 18 extending in a circumferential direction are formed on the outer peripheral surface of the rack guide 14. Then, O-rings 19 sliding on the inner peripheral surface 11a of the housing 11 are fitted to respective grooves 18. Though two O-rings 19 are provided in the rack guide 14 in the embodiment, the present invention is not limited to this.

The compression coil spring 15 is arranged at an approximately central part of the housing chamber 12 seen from the axial direction.

One end side of the compression coil spring 15 is fixed to the housing bottom surface 17a of the rack guide 14 and the other end side of the compression coil spring 15 is fixed to the central part of the bottom surface 13a of the housing chamber 12.

Here, a length L1 between the bottom surface 13a of the housing chamber 12 and the housing bottom surface 17a in a normal state is set to be shorter than a natural length of the compression coil spring 15, and the compression coil spring 15 is compressed in the axial direction. Accordingly, an elastic force of the compression coil spring 15 constantly acts on the rack guide 14 and the rack guide 14 is constantly biased to the rack shaft 6 side.

The elastic force of the compression coil spring 15 in the normal state is set so that the rack shaft 6 can smoothly slide on the sliding surface 14a of the rack guide 14.

The elastic body 16 can be elastically deformed, which is a rubber having a high spring rate. The elastic body 16 according to the embodiment has an annular shape seen from the axial direction, which is fixed to the bottom surface 13a of the housing chamber 12 so as to face the bottom surface (annular surface) 14b of the rack guide 14.

As a fixing method of the elastic body 16, it is possible to fix the elastic body 16 by baking the elastic body 16 to the screw 13 before being screwed to the housing 11 when the elastic body 16 is made of, for example, a rubber, however, the present invention is not limited to this.

A thickness of the elastic body 16 (a length in the axial direction) L3 is shorter than a length L2 between the bottom surface 14b of the rack guide 14 and the bottom surface 13a of the housing chamber 12 in the normal state. In the normal state, the elastic body 16 is fixed to the bottom surface 13a of the housing chamber 12 in the natural length state.

Accordingly, the elastic force of the elastic body 16 does not act on the rack guide 14 in the normal state. Therefore, the biasing force acting on the rack guide 14 is only the elastic force of the compression coil spring 15.

The elastic body 16 is separated from the bottom surface 14b of the rack guide 14 in the axial direction (moving direction of the rack guide 14), and a gap S is formed between the elastic body 16 and the bottom surface 14b of the rack guide 14. Accordingly, if the screwing amount of the screw 13 is increased by the gap S, the elastic force of the compression coil spring 15 can be adjusted without crushing the elastic body 16 onto the bottom surface 14b of the rack guide 14.

Next, a case where the external force is inputted to the steered wheels 8, and the rack shaft 6 presses the rack guide 14 to the other end side of the axial direction against the biasing force of the compression coil spring 15 will be described.

When the pressing force pressing the rack guide 14 is small, a movement amount of the rack guide 14 is also small and the bottom surface 14b of the rack guide 14 does not contact the elastic body 16. Accordingly, the biasing force acting on the rack guide 14 is only the elastic force of the compression coil spring 15. Then, the rack guide 14 returns to the rack shaft 6 side by the elastic force (biasing force) of the compression coil spring 15.

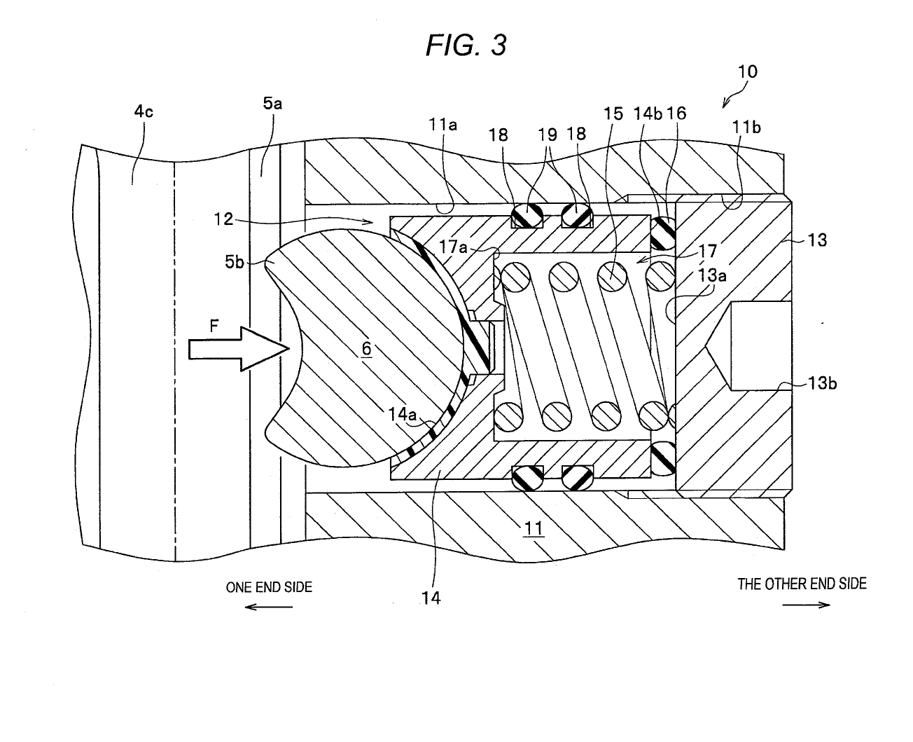

When the pressing force pressing the rack guide 14 is large and there is a danger that the bottom surface 14b of the rack guide 14 collides with the bottom surface 13a of the housing chamber 12, the bottom surface 14b of the rack guide 14 collides with the elastic body 16 and the elastic body 16 is crushed by the rack guide 14 as shown in FIG. 3.

Then, the elastic force of the elastic body 16 acts on the rack guide 14 in addition to the elastic force of the compression coil spring 15, therefore, the biasing force to move the rack guide 14 to the rack shaft 6 side is increased. As a result, the rack guide 14 returns to the rack shaft 6 side without contacting the bottom surface 13a of the housing chamber 12.

As the elastic force of the elastic body 16 does not act on the rack guide 14 in the normal state through the elastic body 16 is provided in the embodiment, the biasing force acting on the rack guide 14 is only the elastic force of the compression coil spring 15. As a result, the rack shaft 6 smoothly slides with respect to the sliding surface 14a of the rack guide 14, and good steering feeling can be obtained.

Also, when the external force acts and there is a danger that the bottom surface 14b of the rack guide 14 collides with the bottom surface 13a of the housing chamber 12, the biasing force acting on the rack guide 14 is improved, therefore, the bottom surface 14b of the rack guide 14 hardly collide with the bottom surface 13a of the housing chamber 12 and generation of a hammering sound is suppressed.

The elastic body 16 is fixed to the portion facing the bottom surface (annular surface) 14b of the rack guide 14, and the elastic body 16 is interposed between the bottom surface 14b of the rack guide 14 and the bottom surface 13a of the housing chamber 12 in the embodiment. Accordingly, the collision between the bottom surface 14b of the rack guide 14 and the bottom surface 13a of the housing chamber 12 can be avoided and the generation of the hammering sound can be positively prevented.

The rack guide mechanism 10 according to the embodiment has been explained as described above, however, the present invention is not limited to this.

In the present embodiment, the portion where the elastic body 16 is fixed is a position facing the bottom surface (annular surface) 14b of the rack guide 14, however, it is also possible to fix the elastic body 16 to the bottom surface (annular surface) 14b of the rack guide 14.

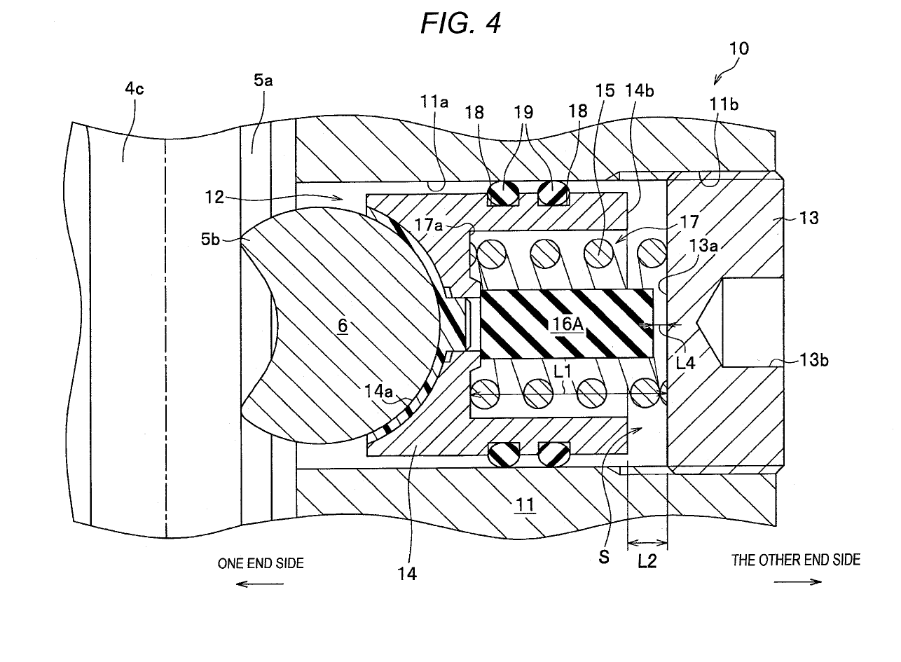

Additionally, it is also possible to fix a columnar elastic body 16A to the housing bottom surface 17a of the rack guide 14 (see FIG. 4), or that the columnar elastic body 16A is fixed to the central part of the bottom surface 13a of the housing chamber 12.

However, when the elastic body 16A is fixed to the housing bottom surface 17a of the rack guide 14 or the central part of the bottom surface 13a of the housing chamber 12, the bottom surface 14b of the rack guide 14 may collide with the bottom surface 13a of the housing chamber 12 while the elastic body 16A does not collide with the bottom surface 13a (or the housing bottom surface 17a) of the housing chamber 12 in the case where the elastic body 16A is short in length.

Accordingly, when the elastic body 16A is fixed to housing bottom surface 17a of the rack guide 14 or the central part of the bottom surface 13a of the housing chamber 12, it is necessary to set a length of the elastic body 16A so that a length L4 between the elastic body 16A and the bottom surface 13a of the housing chamber 12 (or the housing bottom surface 17a) is shorter than the length L2 between the bottom surface 14b of the rack guide 14 and the bottom surface 13a of the housing chamber 12 in the normal state.

The elastic body 16 according to the present embodiment is formed to be have annular shape, and it is also preferable, for example, that plural protruding elastic bodies are prepared to be fixed so as to be arranged in an annular shape on the bottom surface 13a of the housing chamber 12 or the bottom surface 14b of the rack guide 14.

Furthermore, the elastic body 16 according to the present embodiment is separated from the facing bottom surface 14b of the rack guide 14, and the elastic body 16 according to the present invention may be in the natural length state.

Accordingly, it is also preferable that the thickness (the length of the axial direction) L3 of the elastic body 16 is the same as the length L2 between the bottom surface 14b of the rack guide 14 and the bottom surface 13a of the housing chamber 12 in the normal state, and that the elastic body 16 abuts on the facing bottom surface 14b of the rack guide 14.

Though the elastic body 16 according to the embodiment is made of rubber, the present invention is not limited to this, and can be made of materials which can be elastically deformed.

What is claimed is:

1. A rack guide mechanism comprising:
a housing in which a housing chamber opening toward a rack shaft is formed;
a screw screwing to the housing and forming a bottom wall of the housing chamber;
a rack guide housed in the housing chamber, and supporting the rack shaft; and
a compression coil spring interposed between a bottom surface of the housing chamber and the rack guide, constantly biasing the rack guide to the rack shaft side,
wherein an elastic body in a natural length state is fixed to one of the bottom surface of the housing chamber and a facing surface of the rack guide facing the bottom surface of the housing chamber.

2. The rack guide mechanism according to claim 1,
wherein the elastic body is separated from the other of the bottom surface of the housing chamber and the facing surface of the rack guide in a moving direction of the rack guide.

3. The rack guide mechanism according to claim 1,
wherein a housing hole opening toward the bottom surface of the housing chamber and housing the compression coil spring is formed on a bottom surface of the rack guide, and
the facing surface of the rack guide corresponds to one of an annular surface which is the bottom surface of the rack guide and a housing bottom surface forming a bottom surface of the housing hole.

4. The rack guide mechanism according to claim 3,
wherein the elastic body is fixed to the annular surface when being fixed to the facing surface of the rack guide.

5. The rack guide mechanism according to claim 3,
wherein the elastic body is fixed to a portion facing the annular surface when being fixed to the bottom surface of the housing chamber.

6. The rack guide mechanism according to claim 3,
wherein the elastic body is fixed to the housing bottom surface when being fixed to the facing surface of the rack guide.

7. The rack guide mechanism according to claim 3,
wherein the elastic body is fixed to a portion facing the housing bottom surface when being fixed to the bottom surface of the housing chamber.

8. The rack guide mechanism according to claim 2,
wherein a housing hole opening toward the bottom surface of the housing chamber and housing the compression coil spring is formed on a bottom surface of the rack guide, and
the facing surface of the rack guide corresponds to one of an annular surface which is the bottom surface of the rack guide and a housing bottom surface forming a bottom surface of the housing hole.

9. The rack guide mechanism according to claim 8,
wherein the elastic body is fixed to the annular surface when being fixed to the facing surface of the rack guide.

10. The rack guide mechanism according to claim 8,
wherein the elastic body is fixed to a portion facing the annular surface when being fixed to the bottom surface of the housing chamber.

11. The rack guide mechanism according to claim 8,
wherein the elastic body is fixed to the housing bottom surface when being fixed to the facing surface of the rack guide.

12. The rack guide mechanism according to claim 8,
wherein the elastic body is fixed to a portion facing the housing bottom surface when being fixed to the bottom surface of the housing chamber.
